(19) United States
(12) Patent Application Publication
(10) Pub. No.: US 2019/0204909 A1
(43) Pub. Date: Jul. 4, 2019

(54) Apparatus and Method of for natural, anti-motion-sickness interaction towards synchronized Visual Vestibular Proprioception interaction including navigation (movement control) as well as target selection in immersive environments such as VR/AR/simulation/game, and modular multi-use sensing/processing system to satisfy different usage scenarios with different form of combination

(71) Applicant: QUAN XIAO, Beijing (CN)

(72) Inventor: QUAN XIAO, Beijing (CN)

(21) Appl. No.: 15/857,570

(22) Filed: Dec. 28, 2017

(51) Int. Cl. G06F 3/01; G06T 19/00; G06T 19/20; A63F 13/211; A63F 13/212; A63F 13/25

(52) U.S. Cl. CPC G06F 3/012; G06T 19/006; G06F 3/011; G06T 19/20; A63F 2300/8082; A63F 13/212; A63F 13/25; G06T 2219/2016; A63F 13/211

(57) ABSTRACT

This invention is about method and apparatus to provide realistic and anti-motion-sickness of movement/navigation simulation in VR. More specifically about using an innovated “user-intentional head/body motion/acc initiating/surge movement” detection method/apparatus to determine user's intention of movement (such as acceleration aptitude and speed) from user's self-motion and mapping to self-motion in the virtual worlds, with optional haptics/tactile feedback to enable “same spot” (single step range) navigation/movement in simulated environment that towards significantly reduced or eliminated motion sickness caused by the “artificial acceleration/deceleration (including rotation)” in virtual environment (that does not match 100% in real life). This could (optionally) with multi-use modular sensing/processing system to satisfy different usage scenarios requiring different ways of interaction with different form of combination of hardware.

### CROSS REFERENCE TO RELATED APPLICATIONS

The present application claims priority from U.S. Provisional Patents Application Ser. Nos. 62/439,635 and 62/510,260 filed Dec. 28, 2016 and May 23, 2017 respectively, the full disclosures of which are hereby incorporated by reference herein.

### TECHNICAL FIELD

The present invention relates to provide realistic and anti-motion-sickness of movement/navigation simulation in VR. (optionally) with multi-use modular sensing/processing system to satisfy different usage scenarios requiring different ways of interaction with different form of combination of hardware.

### BACKGROUND AND SUMMARY OF THE INVENTION

In the current stage of VR it is proved to be quite difficult to prevent motion sickness (at least for a portion of the user) in action-packed contents with a lot of self-motion such as in a First Personal Shooter (FPS) game where user could perform a lot of sudden movement and change of direction/turning which created a lot of artificial acceleration/deceleration in visually that disconnect with vestibular senses and proprioception (senses from proprioceptors) of human, unlike on a small screen, in an immersive environment like VR or AR this proved to be capable of causing motion sickness quite easily for large number of users. Such phenomenon is also confirmed by many earlier simulator experiments for improving flight simulator. Currently, the known successful example for reducing/eliminating the motion sickness for “artificial” acceleration are very limited in VR/simulation, such as using “VR teleportation” way of movement which is not natural to user. While the so called “1:1 room scale” movements does cause very little motion sickness, this is because user's actual movement/acceleration in real life matches 1:1 of the movement in virtual world, so there is virtually no “artificial” acceleration/rotation applied to user. However there are many limitation of this “1:1” room scale such as limited range and obstacles so make it almost impossible to purely rely on this form of motion control. For example in many open world game/simulation the area of the virtual world is quite big such as more than few squire kilometers so the required area make it impractical for any 1:1 simulation. It will be much more preferable if the experience can be provided “on the spot”/within a small range to cover a large area in the virtual world. Currently some on-the-spot solutions such as 2-D tread mill and “Omni” are heavy and bulky and also have acceleration/deceleration issues that might not only cause motion sickness but also cause user's balance issues. In another related embodiment the user's buoyancy in the underwater environment is adjusted to a desired level.

This invention is about method and apparatus to provide realistic and anti-motion-sickness of movement/navigation simulation in VR. More specifically about using an innovated “user-intentional head/body motion/acc initiating/surge movement” detection method/apparatus to determine user's intention of movement (such as acceleration aptitude and speed) from user's self-motion and mapping to self-motion in the virtual worlds, with optional haptics/tactile feedback to enable “same spot” (single step range) navigation/movement in simulated environment that towards significantly reduced or eliminated motion sickness caused by the “artificial acceleration/deceleration (including rotation)” in virtual environment (that does not match 100% in real life). This could (optionally) with multi-use modular sensing/processing system to satisfy different usage scenarios requiring different ways of interaction with different form of combination of hardware.

This current invention using a light weight wearable system to provide a unique way to reliably detect user's movement intention, to provide a natural/intuitive way of navigation which only require a small area (“single step range”) as user are basically “on the same spot”, so it resolved the problem of 1:1 “room scale” simulation that requires user to travel extended length of distance, it also provide a unique and intuitive way for effectively reducing motion sickness caused by artificial acceleration/deceleration (which can not be avoided in the “same spot” situation). With the help of wireless HMD it will allow unlimited turning (more than 360 degree)

Haptic/tactile feedback that matches user experience/movement or prompt user when obstacle is hit in the virtual world can also provided with the wearable design.

In FPS there's also a problem of tied direction of view-aim-walking, means the direction of user looking, weapon aiming and moving all tied together thus the movement user has to perform is not natural (unlike in real life) in order to achieve the same effect in real life. In VR this is improved as head/view can move freely, independent from the other 2 directions, however the aiming/target selection and body motion are still tied together (or not being able to move at all), so “free aiming+moving” is still not achieved (you can not move forward and shoot targets not in that same direction at the same time). With the help of this hardware, it is possible to achieve the full separation of the 3 directions and true free aiming and moving in FPS-like environments in VR/AR or on the screen.

### Some Important Concepts/Definitions

As used in this description and the accompanying claims, the following terms shall have the meanings indicated, unless the context otherwise requires:

IMU—here refer to inertia measurement unit, this is currently usually integrated circuit

MEMS device/sensor that can provide multiple degree of freedom (DOF) inertia and navigational signals such as acceleration (x,y,z), rotation (angular speed, around x,y,z axis), 3d-magnetic compass (x,y,z direction) and etc.

VIMS—Visually Induced Motion Sickness

VE—Virtual Environment, such as (but not limited to) those created by VR or AR system

CG—Center of Gravity

PI theory—Postural Instability theory

CU—central unit (a wearable)

“vr qualifying low latency”—A quality of detector/detection method in which the latency of detection is lower than the requirement for preventing motion sickness in VR, usually significantly under 20 ms for a event (such as motion) happen to be detected (and desirably processed/communicated) to allow the whole “motion to photon” cycle of VR to be completed under 20 ms)

V-V-P or VVP—brief for “Visual Vestibular Proprioception” (as in title)

“view-coupled-with-turning game/VR system” is a system like traditional FPS in which the turning of body orientation (movement direction) affects the looking direction of user (user camera) in game/VR environment, so that when user turning by for example using joystick/game pad buttons, the view displayed to user also turn together—this however makes user motion sick

User intentional motion initiated translation: the translation (of user position) is caused by intentional (body) movement initiated by user (not just finger movement).

“linear/continuous” way—which unlike “teleportation” which jumping from place to place and make the motion “un-linear”

“R-to-V-similar-mapping” means in translation motion the translation motion of the real world and that of the virtual world are in the same direction, although not necessarily 1:1 in travel distance, while in rotationally motion of virtual world around axis vertical to ground it is mapped substantially 1:1 to user's turning in real world

VE-appropriate-mapping signals for locomotion navigation/modification of self-motion in VR: means signals are mapped in a way so that the directions are in “R-to-V-similar-mapping” in which similar to the peak of user motion speed in real world, the speed in virtual world will also peak at the same time, and become lower as user decelerate, as user will deceleration in the later part of the motion on the direction of motion after performing a one step motion, however the speed in virtual world is diminishing less than what user decelerate in real life (and the difference or mapping can be configurable) so Accl_V (acceleration in Virtual World) could be a function of Accl_Real (user acceleration in real world) in case user decelerating from the top speed of that motion direction, and Accl_V is lower than Accl_Real, desirably in a range user can not perceive or hardly noticeable, so that when user stops in real world after one step (shifting weight to the foot in front), there's still remaining speed in VR environment.

“jumping or cushioning activity criteria”: such criteria is for the detected body/torso acceleration or head acceleration (or obtain measurements from related detection system such as that of the HMD) mainly in the direction of gravity (and might together with rotation) for determining if user is performing jumping or the landing/cushioning activity, if such acceleration in the direction of gravity has a “spike” significantly more than normal/stationary situations (like 120% or more of the stationary/“standard” gravity acceleration measured), and optionally if this change is also confirmed by foot pressure pattern or foot motion detectors at roughly the same time, the system can assume user is doing intentional jumping and such event together with related information (such as direction, aptitude) can be communicated to the virtual world presented by such as VR/AR/Game/Simulation system and modify user's motion status. On the other hand the landing/cushioning activity of user can also be determined by checking the acceleration of body, if the acceleration on the gravity direction have a dip significantly less than normal/stationary situations (like 85% or less than the stationary gravity acceleration measured), and optionally if also confirmed by foot pressure pattern or foot motion detectors at roughly the same time, the system can assume user is doing intentional landing/cushioning and such event together with related information (such as direction, aptitude) can be communicated to the virtual world presented by such as VR/AR/Game/Simulation system and modify user's motion status.

### DESCRIPTION OF PREFERRED EMBODIMENTS

<Section 0>

An apparatus to provide intuitive and anti-motion-sickness navigation by detecting user initiated intentional motion within a limited range (such as a single step range) comprised of:

A “head/body motion detection” system that either a) detecting user body torso motion by using wearable fixed on user's torso (such as IMU/beacon or receiver for navigational “light house” like those of HTC vive) which operationally connects to a computer based processing system for determine user intensions from body movements and/or status change and communicate body motion or pose/status changes detected in real-time to said system; or b) detecting head motion or operationally connecting to detection mechanism (such as those of a HMD) and capable of getting the motion measurements in real time; in this case the rotation of user's head/HMD is not considered to be also the body rotation unless otherwise deliberately choose by user c) the combination of the above which could provide improved acceleration/translation movement measurement of user, and the rotation of user's body is determined by the sensor system for detecting user torso motion;

A system to detect user's feet motion by using wearable fixed on user's feet (such as foot pressure pattern sensors/IMU/beacon or receiver for navigation signal emitter such as “light house” of HTC vive) which operationally connects to a computer based processing system for determine user intentions from body movements and/or status change and communicate foot motion/pressure pattern change detected in real-time to said system;

Said system operationally connects to a computer implemented VR/AR/Game/Simulation system that present a virtual world to user; the input from body/torso motion detection system and the foot motion/pressure change detection system is used for deciding if user's activity is intentional by comparing the direction, timing and duration of the motion from body and feet and if considered together the 2 match a profile of a intentional movement such as translation (maybe similar to that of FIG. 1), said (computer implemented VR/AR/Game/Simulation) system will start modifying (or make changes) to the virtual world system on user's self-motion (such as velocity relative to the virtual world) according to such intentional changes in real time, such modification does not render user to have motion sickness with ways to make the differences (between the artificial motion state and that in real life) difficult to notice (for example using noise to mask related differences) or unnoticeable (such as below normal person's sensing threshold for acceleration or rotation) or other methods that introduce little motion sickness, for example the difference is added mainly at phases when user's acc or velocity is diminishing (notice we need to balance the user for this)

In a related embodiment, any new movement direction or turning will require user to begin a new step and the current speed could be dropped significantly (according to some configurable parameter such as dropping rate or ratio) in the process of taking another step, so that the new direction does not create a lot of centrifugal forces in virtual world for user to compensate.

In one embodiment, such moving sensation is enhanced by haptics/tactile feedback for example but not limited to: simulation of impact of feet to the ground (which could be periodically), simulation noise/vibration in the movement (caused by such as but not limited to the “non-smooth” spot on the way such as dips, bumps); impact by hitting/collision with virtual objects such as glass or stone (which could have difference strength and variation profile), hitting virtual boundaries/limits (such as but not limit to walls, obstacles and etc) defined in the virtual world, and etc. so that user can have a visual and proprioception/tactile synchronized experience for the action he/she took.

In a related embodiment, further including using the detected body/torso rotation (and might together with acceleration) to determine the direction of self-motion in the virtual world (which do not need hand based input) in a 1:1 way—for example if user's body turned left 35 degrees in real life environment, in virtual world the direction for self motion also turned left 35 degrees.

In a related embodiment, the motion of user are divided into sessions (for example for clear separation of rotation and translation); such session can be determined by events such as (but not limit to) steps, for example only when a new step is taken and then landed and put more than for example 15% (around ⅙) weight on it we can begin to tracking “in a new step session/context”, otherwise if no new step is taken we just “modify” the current “step session” (which basically CAN NOT change from turning to translation or vice versa, but only on the same direction with aptitude modifications). Changing from rotation to translation or vice versa is only possible after a new step is detected/confirmed; If landed (with more than 15% whole body weight on frontal foot) and the body direction is already departed from that of the previous step session, and increasing, we can determine this session is a “turning” session; to determine if a landed feet is forward or backward, there could be multiple ways, one way using just the pressure sensor is to referring to the “landing pressure pattern sequence” to determine—if the pressure pattern is from heal to toe, it can be assumed the foot is landing forward, and if the pressure pattern is toe to heal, it can be assumed the foot is landing backwards, same can be applied to left to right side ways situations.

In a related embodiment, any new movement direction or turning will require user to begin a new step and the current speed could be dropped significantly (according to some configurable parameter such as dropping rate or ratio) in the process of taking another step, so that the new direction does not create a lot of centrifugal forces in virtual world for user to compensate.

In a related embodiment, further including using the detecting body/torso acceleration or detecting head acceleration (or obtain measurements from related detection system such as that of the HMD) mainly in the direction of gravity (and might together with rotation) to determine if user is performing jumping or the landing/cushioning activity, by checking the acceleration of body/head, if such acceleration in the direction of gravity has a “spike” significantly more than normal/stationary situations (like 120% or more of the stationary/“standard” gravity acceleration measured), and optionally if this change is also confirmed by foot pressure pattern or foot motion detectors at roughly the same time, the system can assume user is doing intentional jumping and such event together with related information (such as direction, aptitude) can be communicated to the virtual world presented by such as VR/AR/Game/Simulation system and modify user's motion status. On the other hand the landing/cushioning activity of user can also be determined by checking the acceleration of body, if the acceleration on the gravity direction have a dip significantly less than normal/stationary situations (like 85% or less than the stationary gravity acceleration measured), and optionally if also confirmed by foot pressure pattern or foot motion detectors at roughly the same time, the system can assume user is doing intentional landing/cushioning and such event together with related information (such as direction, aptitude) can be communicated to the virtual world presented by such as VR/AR/Game/Simulation system and modify user's motion status. In case user landing but do not performing cushioning activity, the VR system might generate visual effects such as shake, blur or black out according to the simulated impact in the virtual world.

In an method to reduce motion sickness in motion in virtual worlds including detecting a cushioning/bracing movement of user in real life and apply cushion or soften the impact in the virtual world, this including detecting user intentional movement within a single step range and if the body movement (translation) acceleration matches the profile of a cushioning activity—basically a “braking motion” in which the acceleration provided by user body motion in real life can be at least partially reduce the amount of impact acceleration in virtual world, the a brace/cushioning events together with related information (such as direction, aptitude) can be communicated to the virtual world presented by such as VR/AR/Game/Simulation system and modify user's motion status and soften the impact in virtual world (such as when user hit the ground or a wall) and reduce the discrepancy of accelerations between real world and in the virtual world (visually). In a case a collision/impact happened in virtual world but no cushioning activity is detected from user, the VR/Simulation system might generate visual and optionally tactile effects such as shake, blur or black out according to the simulated (hard) impact strength in the virtual world.

In a related embodiment, the mapping ration of speed of motion in real life to virtual world might be variant and could be related to the speed real-life (such as in proportion to X times itself n times (n>1) or mapped in proportion to exponentially like exp(x)) with optional adjustable factor which creates a naturally (and intuitively) accelerated motion mechanism—when user fast move he/she can get to the destination area faster and when user move slowly he/she can precisely get to the location, a control similar to that of the mouse.

Body motion detection, foot motion detection (and optional tactile feedback), together with A system to based on the “consistency” of the body-foot movement (according to profile) to output velocity modifications to VR system that is in general below the “washout” thresholds, and does not allow the difference in acceleration (not speed) above the noticeable threshold to exist for long period (such as more than 1 seconds) of time. We can, however, like the mouse, allow fast non-linear displacement, but such “acceleration” will stop almost at the same time as user stops fast intentional motion.

Such intentional acc can also be controlled by other trigger such as button or gesture, or from program.

<Section I>

A first embodiment of a system/method for comfortable locomotion/navigation of a user in a virtual environment such as VR (virtual reality)/AR towards reducing/minimizing VIMS (for some longer than trivial—such as more than 3 minutes—usage) includes:

1) detecting user motion (in a limited range such as within one step) including body/head/CG and possibly also with feet/leg movement, such movement including translation and turning.

2) convert motions suitable for reducing/minimizing VIMS purpose which is parallel to the direction of moving (such as those directions user can move in VE), and optionally after determine if such movement is intentional, into appropriate signals for locomotion navigation/modification of self-motion in VR in real time that can rendering the self-motion speed in VE visually changed by this motion in a similar way (by similar means in translation motion they are in the same direction, although not necessarily 1:1 in travel distance, while in rotationally motion around axis vertical ground it is mapped substantially 1:1 to user's turning in real world), for example similar to the peak speed of user motion in real world, maybe lower as user decelerate—because user just perform one step motion so he/she will deceleration in the later part of the motion on the direction of motion, however the speed in virtual world is diminishing less than what user decelerate in real life (and the difference or mapping can be configurable) so Accl_V (acceleration in Virtual World) could be a function of Accl_Real (user acceleration in real world) in case user decelerating from the top speed of that motion direction, and Accl_V is lower than Accl_Real, desirably in a range user can not perceive or hardly noticeable, so that when user stops in real world after one step (shifting weight to front foot), there's still remaining speed in VR. if user place their weight on the foot that is “in front” to the direction of moving, for example if user translation (stride) to the left, then left foot is considered the foot that is in front, and moving to right foot means shifting CG to the “back foot” and will slow down or move in reverse direction; Converting user's turning (body orientation change) 1:1 to turning in virtual world.

So that what user sees in VR and the cues user got from his/her inner ear (vestibular) have reduced/minimized conflict at a level either is not noticeable (such as but not limited to below noticeable threshold) for most (over 80%) of the population or enable most (over 80%) of the population to feel comfortable in navigation continuously for prolonged period of time (such as more than 15 minutes) in a immersed virtual environment. (as human's acceleration is not perfect and the acceleration difference can be “faded” or “washout”) using special techniques controlling the difference between virtual world and real world, some methods maybe similar to that of a flight simulator).

In a related embodiment, further include Filtering out Non-qualified, using software/signal processing.

In an related embodiment, the acceleration difference can be “faded” or “washout” using techniques controlling the difference between virtual world and real world, some methods maybe similar to that of a flight simulator so that even when artificial movements/acceleration is added (different thus not strictly 1:1 with user motion in real world) it will be either is not noticeable (such as but not limited to below noticeable threshold) for most (over 80%) of the population or enable most (over 80%) of the population to feel comfortable for prolonged period of time (such as more than 15 minutes) in a immersed virtual environment.

An embodiment of a system/apparatus to enable comfortable locomotion/navigation of a user in a virtual environment such as VR (virtual reality)/AR which reduces/minimizes VIMS (for some longer than trivial—such as more than 3 minutes—usage) comprised of:

Means for detecting user motion in a limited range (such as within one step) including body/head/CG and possibly also with feet/leg movement, such movement including translation and turning.

Said means can either perform or operationally connected to one or more computer implemented systems that perform the steps of convert motions suitable for reducing/minimizing VIMS purpose which is parallel to the direction of moving (such as those directions user can move in VE), and optionally after determine if such movement is intentional, into appropriate signals for locomotion navigation/modification of self-motion in VR in real time that can rendering the self-motion speed in VE visually by this motion similar to the peak speed of user motion in real world, maybe lower as user decelerate—because user just perform one step motion so he/she will deceleration in the later part of the motion on the direction of motion, however the speed in virtual world is diminishing less than what user decelerate in real life (and the difference or mapping can be configurable) so Accl_V (acceleration in Virtual World) could be a function of Accl_Real (user acceleration in real world) in case user decelerating from the top speed of that motion direction, and Accl_V is lower than Accl_Real, desirably in a range user can not perceive or hardly noticeable, so that when user stops in real world after one step (shifting weight to front foot), there's still remaining speed in VR. if user place their weight on the foot that is “in front” to the direction of moving, for example if user translation (stride) to the left, then left foot is considered the foot that is in front, and moving to right foot means shifting CG to the “back foot” and will slow down or move in reverse direction; Converting user's turning (body orientation change) 1:1 to turning in virtual world.

So that what user sees in VR and the cues user got from his/her inner ear (vestibular) have reduced/minimized conflict at a level either is not noticeable (such as but not limited to below noticeable threshold) for most (over 80%) of the population or enable most (over 80%) of the population to feel comfortable in navigation continuously for prolonged period of time (such as more than 15 minutes) in a immersed virtual environment. (as human's acceleration is not perfect and the acceleration difference can be “faded” or “washout”) using special techniques controlling the difference between virtual world and real world, some methods maybe similar to that of a flight simulator).

In a related embodiment, further include Filtering out Non-qualified signal from user motion, for example using software/signal processing.

In an related embodiment, the acceleration difference can be “faded” or “washout” using techniques controlling the difference between virtual world and real world, some methods maybe similar to that of a flight simulator so that even when artificial movements/acceleration is added (different thus not strictly 1:1 with user motion in real world) it will be either is not noticeable (such as but not limited to below noticeable threshold) for most (over 80%) of the population or enable most (over 80%) of the population to feel comfortable for prolonged period of time (such as more than 15 minutes) in a immersed virtual environment.

In a related embodiment, said means for detecting user motion in a limited range (such as within one step) including:

1) a mechanism for (reliably) detecting CG change caused/rendered (or resulted) foot/feet supporting changes including movement or pressure distribution change in real-time low latency (such as lag less than 20 ms),

2) together with mechanism detecting body orientation changes in real-time low latency suitable for VR/AR (such as less than 20 ms) including at least turning around axis vertical to the ground.

In a related embodiment, further include

3) Means (Steps for determine if the motion/change is intended/suitable for locomotion (self-motion) in VE:

A computer implemented system use the input from body/torso motion detection system and the foot motion/pressure change detection system and deciding if user's activity is intentional by comparing the direction, timing and duration of the motion from body and feet and if considered together the 2 match a profile of a intentional movement such as translation (maybe similar to that of FIG. 1), said system will start modifying (or make changes)

A method to generating cues (that is suitable for VIMS reduction) for navigating/modifying user's motion status in visual environment that reduce/minimize VIMS of user including:

Generating cues (motion direction/turning direction) for virtual worlds (in real-time low latency suitable for VR) consistent with user's head/body motion in real world utilizing physical acceleration/motion provided by user's motion within one step so it is roughly consistent (or under noticeable threshold or under comfortable threshold for prolonged such as longer than 15 minutes use in VE) with what normal user feels with his/her vestibular and other senses for acceleration.

So that VIMS is canceled/reduced/minimized in a intuitive way in which physical acceleration/motion provided by user's motion match (or reduce the inconsistency) the artificial acceleration/motion perceived by user from visual from the virtual environment that might be otherwise inconsistent or conflict with user's vestibular senses.

In a related embodiment, Generating cues (motion direction/turning direction) for virtual worlds (in real-time low latency suitable for VR) consistent with user's head/body motion in real world utilizing physical acceleration/motion provided by user's motion within one step includes:

1) detecting user motion (in a limited range such as within one step) including body/head/CG and possibly also with feet/leg movement, such movement including translation and turning.

2) convert motions suitable for reducing/minimizing VIMS purpose which is parallel to the direction of moving (such as those directions user can move in VE), and optionally after determine if such movement is intentional, into appropriate signals for locomotion navigation/modification of self-motion in VR in real time that can rendering the self-motion speed in VE visually by this motion similar to the peak speed of user motion in real world, maybe lower as user decelerate—because user just perform one step motion so he/she will deceleration in the later part of the motion on the direction of motion, however the speed in virtual world is diminishing less than what user decelerate in real life (and the difference or mapping can be configurable) so Accl_V (acceleration in Virtual World) could be a function of Accl_Real (user acceleration in real world) in case user decelerating from the top speed of that motion direction, and Accl_V is lower than Accl_Real, desirably in a range user can not perceive or hardly noticeable, so that when user stops in real world after one step (shifting weight to front foot), there's still remaining speed in VR. if user place their weight on the foot that is “in front” to the direction of moving, for example if user translation (stride) to the left, then left foot is considered the foot that is in front, and moving to right foot means shifting CG to the “back foot” and will slow down or move in reverse direction; Converting user's turning (body orientation change) 1:1 to turning in virtual world.

So that what user sees in VR and the cues user got from his/her inner ear (vestibular) have reduced/minimized conflict at a level either is not noticeable (such as but not limited to below noticeable threshold) for most (over 80%) of the population or enable most (over 80%) of the population to feel comfortable in navigation continuously for prolonged period of time (such as more than 15 minutes) in a immersed virtual environment. (as human's acceleration is not perfect and the acceleration difference can be “faded” or “washout”) using special techniques controlling the difference between virtual world and real world, some methods maybe similar to that of a flight simulator).

In a related embodiment, further include Filtering out Non-qualified, using software/signal processing.

In a related embodiment, Generating cues (motion direction/turning direction) for virtual worlds (in realtime low latency suitable for VR) consistent with user's head/body motion in real world utilizing physical acceleration/motion provided by user's motion within one step includes:

1) Detecting CG change caused/rendered (or resulted) foot/feet supporting changes including movement or pressure distribution change in real-time low latency (such as lag less than 20 ms),

2) Detecting body orientation changes in real-time low latency suitable for VR/AR (such as less than 20 ms) including at least turning around axis vertical to the ground.

In a related embodiment, further includes:

Steps for determine if the motion/change is intended/suitable for locomotion (self-motion) in VE: A computer implemented system use the input from body/torso motion detection system and the foot motion/pressure change detection system and deciding if user's activity is intentional by comparing the direction, timing and duration of the motion from body and feet and if considered together the 2 match a profile of a intentional movement such as translation (maybe similar to that of FIG. 1), said system will start modifying (or make changes)

An embodiment for an apparatus/system to generating cues (that is suitable for VIMS reduction) for navigating/modifying user's motion status in visual environment that reduce/minimize VIMS of user comprised of:

Means for generating cues (motion direction/turning direction) for virtual worlds (in realtime low latency suitable for VR) consistent with user's head/body motion in real world utilizing physical acceleration/motion provided by user's motion within one step so it is roughly consistent (or under noticeable threshold or under comfortable threshold for prolonged such as longer than 15 minutes use in VE) with what normal user feels with his/her vestibular and other senses for acceleration.

Such means is operationally connected to a VE.

So that VIMS is canceled/reduced/minimized in a intuitive way in which physical acceleration/motion provided by user's motion match (or reduce the inconsistency) the artificial acceleration/motion perceived by user from visual from the virtual environment that might be otherwise inconsistent or conflict with user's vestibular senses.

In a related embodiment, Means for generating cues (motion direction/turning direction) for virtual worlds (in real-time low latency suitable for VR) consistent with user's head/body motion in real world utilizing physical acceleration/motion provided by user's motion within one step comprised of:

1) a mechanism for (reliably) detecting CG change caused/rendered (or resulted) foot/feet supporting changes including movement or pressure distribution change in real-time low latency (such as lag less than 20 ms),

2) together with mechanism detecting body orientation changes in real-time low latency suitable for VR/AR (such as less than 20 ms) including at least turning around axis vertical to the ground.

In a related embodiment, further include

3) Means (Steps for determine if the motion/change is intended/suitable for locomotion (self-motion) in VE:

A computer implemented system use the input from body/torso motion detection system and the foot motion/pressure change detection system and deciding if user's activity is intentional by comparing the direction, timing and duration of the motion from body and feet and if considered together the 2 match a profile of a intentional movement such as translation (maybe similar to that of FIG. 1), said system will start modifying (or make changes)

<Section II>

A method/apparatus to allow intuitive (similar to real life) and “linear”/continuous way—which means not “jumpy” or “un-linear” as “teleportation”—navigation/exploration (with self-motion) of a virtual world in which user can navigate (maybe similar to a way user navigate in real life, presented by a immersive VE (for example a VR/AR system) for a user towards minimizing VIMS and without the need of using hand(s) (just like in real life) includes/comprised of:

1) A means for detecting [and identifying] user [intended] body/CG movement that is consistent with navigation direction in VE such as translation horizontally (parallel to the ground) or turning around an axis substantially vertical to ground. (for example tracking means for foot and body motion/position that can track both foot and body movements in real time with “vr qualifying low latency” in which the latency of detection is lower than the requirement for preventing motion sickness usually significantly under 20 ms to allow the whole “motion to photon” cycle of VR to be completed under 20 ms)—So it needs to detect (either directly or indirectly) in low latency when user performing body CG moves or the supporting (such as foot pressure pattern) of user GG changes (deemed to be motions intentional) for the purpose of navigation such as translational movement (horizontally movement in the VE), rotation (around axis vertical to the ground), jumping or crouching, which could means filtering out motions detected other than these purposed (such as with excessive tilt, so short unintentional sway) [Using some threshold on speed (which can be inferred by accelerometer data), distance (support percentage), duration]

2) For translation this means a threshold for example at least ¼ of normal ppl's walking speed (0.6 m/sec, ¼ is 0.15 m/sec) with relatively long period of time or travel distance (such as half step) is desirable to filtering out the noises. For turning this requires a new step and at least 3 degree of turning and continue angular speed to begin turn on.

3) Communicate/inform VE with “detected intention” for rendering modification in real time and low latency suitable for vr/ar purpose, or before user's motion finished (all speed diminished for this intentional movement direction)> of user movement state in the VE, such as transnational speed or turning/facing direction, Causing an “artificial speed/acceleration” to be added to the avatar other than what user already seen in VE (such as but not limited to HMD, CAVE) (such speed will continue until user shift weight back, even when user stopped moving in real life) in a way not very noticeable to user.

So that VIMS can be avoided/minimized by user's motion which is intuitive and provide (consistent) cue(s) of motion to vestibular senses for the motion user sees in the VE system.

In one embodiment, the speed of motion relative to the virtual world have a upper limit or conditional upper limit, for example similar and not significantly higher than human being's max motion speed in a similar situation in real life—for example but not limit to: faster than twice the speed of human running speed. Further, the limitation could be conditional—for example if user are moving in a wide open space/area (in virtual world) with low “visual angular speed” the speed limit is higher, while in a closed space (in virtual world) with high “visual angular speed” the speed limit is lower, maybe even slightly lower than max human running speed to be comfortable for most users.

In a related embodiment, the criteria (threshold) and resulting “detected intention” is like this: once user top speed surpass certain limit, or translation distance greater than how many, we can set a minimal speed when user slowing down (like some thing can be surged)

Said means for detecting [and identifying] user [intended] body/CG movement that is consistent with navigation direction in VE such as translation parallel to the ground

An embodiment to provide reliable/true intention of motion from user's movement including (comprised of:)

1) a mechanism for (reliably) detecting CG change caused/rendered (or resulted) foot/feet supporting changes including movement or pressure distribution change in real-time low latency (such as lag less than 20 ms),

2) together with mechanism detecting body orientation changes in real-time low latency suitable for VR/AR (such as less than 20 ms) including at least turning around axis vertical to the ground.

In a related embodiment, further includes:

3) Means (Steps for determine if the motion/change is intended/suitable for locomotion (self-motion) in VE:

A computer implemented system use the input from body/torso motion detection system and the foot motion/pressure change detection system and deciding if user's activity is intentional by comparing the direction, timing and duration of the motion from body and feet and if considered together the 2 match a profile of a intentional movement such as translation (maybe similar to that of FIG. 1), said system will start modifying (or make changes)

<Section III>

In an embodiment, possible related to the above embodiments, of detecting user body motion direction within one step range and use such motion direction and top speed (of the CG movement) to (factor can adjust) determine the moving speed (continues) of the user in the virtual space proportionally including:

1) determine/estimate Center of Gravity movement combined with body orientation, by for example by detecting user's feet movement in order, for example if user keep their weight (like more than 50%) on the feet in the front of the direction he/she intended to move this could represent user's intention to move along with this direction in the virtual world and it feels natural to user. By detecting such CG movement for an estimation of “vestibular/inner ear sensed” motion status which is closely related to the motion status sensed by vestibular/inner ear and use such estimation (such as acceleration, speed) to drive the movement of visual, with washout filters (maybe similar to the algorithm of the washout filter of a flight/vehicle simulator in similar/comparable situations)

So that VIMS can be avoided/minimized by user's motion which is intuitive and provide (consistent) cue(s) of motion to vestibular senses for the motion user sees in the VE system.

Section IV:

A means for reliably and low-latency detecting and identifying user intended body/CG movement consistent with direction(s) user can navigate to in VE (such as translational parallel to the ground) and thus can be used (suitable) for navigation commands including/comprised of:

1) a mechanism for (reliably and low latency) detecting CG change caused/rendered (or resulted) foot/feet supporting changes including movement or pressure distribution change in real-time low latency (such as less than 20 ms of lag “from motion to photon”),

2) mechanism detecting user body's left or right turning (or: turning around axis substantially vertical to the ground) in real-time low latency (such as lag less than 20 ms)

3) that upon “low latency” realtime detection of user's (intended) CG movement the camera/avatar in VE representing user view point can be changed according to speed vector of the user's motion

So that VIMS can be avoided/minimized by user's motion which is intuitive and provide (consistent) cue(s) of motion to vestibular senses for the motion user sees in the VE system

In a related embodiment, further include

3) Means (Steps for determine if the motion/change is intended/suitable for locomotion (self-motion) in VE:

A computer implemented system use the input from body/torso motion detection system and the foot motion/pressure change detection system and deciding if user's activity is intentional by comparing the direction, timing and duration of the motion from body and feet and if considered together the 2 match a profile of a intentional movement such as translation (maybe similar to that of FIG. 1), said system will start modifying (or make changes)

So that by “low latency” detection user's intended CG movement and use it for VIMS reducing minimizing motion-indication/navigation by

1) modifying the VE or avatar in VE of the speed vector “consistent” or similar to the speed vector of the user's motion, the amplitude/magnitude of translation can be (for example proportion to the top speed) determined by a mechanism for (reliably and low latency) detecting CG change caused/rendered (or resulted) foot/feet supporting changes including movement or pressure distribution change in real-time low latency (such as lag less than 20 ms)

2) from a mechanism detecting user body's left or right turning (or: turning around axis substantially vertical to the ground) in real-time low latency (such as lag less than 20 ms) the body orientation can be determined which can be used to determine user's movement/turning intension.

In a related embodiment, the translation or turning of user can be done by requiring user to use a fixed posture, or by detecting user's foot location

In a related embodiment, User should lean to the direction they want to step (which they actually take one step).

Also the turning is determined by detecting significant body orientation change.

In an embodiment related to embodiment in section I or II or III of the above, detecting body/Center of Gravity movement including using pressure sensor for foot such as on/attached to footware for foot motion and CG supporting status detection and IMU wearable close to user's CG for detecting CG movement.

In an embodiment related to embodiments in section I or II or III of the above, detecting body/Center of Gravity movement including using pressure sensor for foot such as on the floor like a mat that covers user's movement range for foot motion and CG supporting status detection and IMU wearable close to user's CG for detecting CG movement.

In an embodiment related to section I or II or III of the above, detecting body CG movement including using IMU sensor, maybe together with Optical/Ultrasound/pressure sensor on the attached to footwear such as IMU wearable or optical/ultrasound means (such as optical sensors, beacons, optical patterns, reflectors etc.), as well as means to detecting user's body turning such as around axis vertical to the ground, such as by optical/ultrasound (such as sensors, beacons, optical patterns, reflectors etc.) or IMU means worn close to user's CG.

In an embodiment related to embodiments in section I or II or III of the above, detecting body CG movement including using optical means such as markers/beacons using outside cameras, or receivers such as light house trackers, maybe together (2) which could also use with Optical/Ultrasound/pressure sensor on the attached to footware/Or using matt-like outside foot pressure sensor (such as IMU wearable, or outside optical sensors, beacons, patterns) as well as means to detecting user's body turning such as around axis vertical to the ground, such as by optical/ultrasound (such as sensors, beacons, optical patterns, reflectors etc.) or IMU means weared close to user's CG.

In an embodiment related to embodiment in section I or II or III of the above, the detecting of “CG change caused/rendered (or resulted) foot/feet supporting changes” including optical tracking (such as active tracking by camera or passive tracking by detecting beacon or “lighthouse” coordinate) of user's foot, or by using IMU(s) (for example 9DOF IMU) on sections or joints connecting to foot—such as on lower portion (calf part) of leg, to thigh to hip—which forms a “kinetic chain”—which from individual 3D position and orientation of each section the status of the chain and its endpoint (foot) can be determined.

1.1 in a related embodiment said “kinetic chain” detection can also use optical tracking (such as placing beacon on/close to joints or use “Kinect” like camera+3D point cloud detection for determining or estimation limbs/joints 3D position/orientation) instead of placing IMU on the related articulated sections of body limbs,

1.2<One foot+CU IMU (accelerator) detection>: An alternative embodiment for body/CG movement detection as mentioned in sections above would be: Using the one foot place in front for primary control, by detecting if it is grounded (such as by pressure or by optical/ultrasound means) or not, if not then we can treated this as “during transition between motion states”, and if we found the foot is grounded and observed a translation from IMU that is worn close to user's CG (for example by filter out the most obvious TRANSLATION, and not tilting or turning is kind of easy, we can have specific logic in signal processing to give a estimated “score” instantly for this, rather than have a lot latency.) or by optical means/sensors, we can determine such movement is a translation that is intentional for navigation purpose.

1.3 In a related embodiment, the foot tracking includes using a (relative) flat and stationary detector (array/matrix) on/over the floor which user stands on (such as carpet like/mat like) detection means to detect user foot motion, together with tracking of user's body orientation by means of optical or IMU, to determine the “intention of movement” or “the vestibular sensed motion status”

In one embodiment, contains at least one pose-sensing node for the body, said pose-sensing node connect to sensors for determining foot movement or pressure, or both. Such sensor can be wearable to the foot and sensing multiple point of pressure (pattern) of both feet. It might also sense other aspects such as acc, rot but not as important, and optionally also provide tactile feedback.

In X or Y Axis (Horizontal)

While user's two feet pressure pattern change to be like 85%-15% or more, over one feet, it will be determined user intention to move. The dir is according to body motion acc and gyro reading from earlier records when it is like 70-30 or 75-25 more like, by looking at such diff we should be able to determine the dir

After such direction and aptitude is determined and user's velocity of “initiation action/surge” have not diminished, modify the velocity in the VR system (from what is really measured) and keep the residue, (and might decay or increase, means deceleration or acceleration) when user change from current position, for example from 85-15 distribution to 95-5 distribution, the artificial speed will increase, or if it is from 85-15 distribution to 70-30 the speed will deceleration. SO basically the speed will be modified from the new base with adjust-able natural “decay”/diminishing to zero (simulating friction in real life and energy—throttle needs to put on to it), if user back to around 50-50, it will naturally/gradually stop. User can brake by using 20-80 which will naturally generate a deceleration, and while this intension shift/change is detected, a surge “brake” speed is added to the “current” speed while user's action velocity is not yet diminished. (This is like the mouse “acceleration” which comes natural to user: when moving above a certain speed threshold, it will double or tripled, or square/exp the speed,) in or case exp the acceleration to keep some remaining speed, of course we still needs to confirm with pressure change in feet (if there's no new step detected) basically there are 2 things, if user took a new step that is intentional, or if user shift very fast for a distance that

In an embodiment (of apparatus), a foot wearable that can be fitted to shoes or by itself a shoe which can accommodate user's feet, comprised of:

Localized pressure sensor based CG detection mechanism which capable of detecting user's weight distribution on 2 feet and minor changes, in at least 4 or 5 points each feet.

Distance/range measurement mechanism which can determine/measure the distance between the 2 feet;

Haptics/Tactile feedback mechanism which can provide dynamic, pattern based feedback to user to indicate motion;

So that when user occupy such apparatus, system can use “external” acc data of head and compare with the data of 2 distance and the weight distribution, and if they mach, give out navigation and process deceleration, and feedback.

In a related embodiment, determining the distance between the 2 feet including using an optical method including one or more camera(s) on one feet that can “see” beacon or visual patterns on the other feet and can from the image (such as the location and size of the pattern) to determine the distance and the orientation of the other feet; such camera might be IR or visible (pattern or beacon)

In a embodiment related to 1, determining the distance between the 2 feet including using an ultra-sound method including one or more receivers (microphone) on one feet that can “hear” ultrasound signal from ultra sound transmitter/speaker/beacon on the other feet, from time-lapse and maybe even phase (if 2 or more detectors) of the signal to determine the distance and the orientation of the other feet;

In an example embodiment for VR navigation (give out motion indication for continues movement), in which the movement is initiated by user's body including head, mainly the vestibular system and NOT by any “indirect” indications by for example user's fingers, with wearable sensors on user's torso and shoes, including:

1. Detecting a translational movement (not rotation-heavy) which mainly on the X-Y (horizontal) dimension, and could be little on the Z (vertical) dimension (which indicate rotation or jump/crunch) of user's head (and body, basically the body have a bit rotation but also have movement), only when a new step is taken and then landed and put more than 15% (⅙) weight on it we can begin to tracking “in a new step context”, otherwise if no new step is taken we just “modify” the current “step session” (which basically CAN NOT turn, only on the same direction fwd and stop, not even backwards in some option). after we detect/confirm this is a new step, we are allow to change direction, if landed (15%) and we found the body direction is already departed from the previous step session, and increasing. Also determine how user's feet landed is also important, because we are not fully know the foot new location, we use the “sensor landing sequence” to determine, if it is heal to toe, we assume it is forward, toe to heal backwards, left to right then side ways.

notice in one related embodiment A turning step CAN NOT be used for acceleration-deceleration, User needs to take a new step for moving translational such as backwards, or forwards or sideways.

In one related embodiment an accumulation of acceleration, and rot during a new step is performed (once one feet is less than 80% we begin, and will discard the data if it is not down to 0 (or less than 6%), so that we know what is estimated current speed and rot at any time user landed the feet, from 10% to calculate. and begin to turn on “residue” (later) or determine if this is indeed a turning. So when user step to one side and turn, we do not increase the speed (just decay the current speed to zero for example), only when we confirmed after 60% there's little turning (not much side way acc, not much rot detected) all the Detecting Center of Gravity (CG) using pressure sensing means which capable of detecting user's weight distribution on 2 feet and minor changes, in at least 4 or 5 points each feet., or optionally using optical detection

Determining distance/range/measure the distance between the 2 feet by using for example optical based or Ultra-sound based measurement mechanism;

Only when user initiated the translational movement which pass some threshold (such as distance “surge distance”, speed), and when it is confirmed by the CG movement determined by the pressure sensors, will system issue navigation movement (with constant speed), such speed is the same direction as user initiated, and slower than the max speed when user initiated the action (but in proportion), then the VR system is given a constant speed or very slowly decreasing (not noticeable), not something that will alarm the balance nerve system—since the Fwd Back direction is less sensitive than the lateral (LR) direction, and the speed/acc in the LR is smaller than the FWBW direction.

A computer system combine these inputs from shoes and possibly legs plus using “external” acc data of head and compare with the data of 2 distance and the weight distribution, and if they mach in direction (and speed, and type), give out navigation and process deceleration, and feedback.

In a related embodiment, further includes providing dynamic, pattern based feedback to user to indicate motion with Haptics/tactile feedback mechanism in contact with user's foot area (foot wearable) and possibly other areas of human body;

In a further related embodiment, providing dynamic, pattern based feedback includes providing tactile feedback—for example when moving to left, user will feel vibration/hit sequence dynamic pattern formed from multiple tactile feedback mechanisms/tactor (or speaker, transducer) located on different points of user's feet, such pattern “moves” at the same speed or pace as the simulated movement speed (or the gait speed, alternative of 2 feet hitting the ground);

So that user feel the pattern's movement mach the visual movement of the virtual world;

Other motion such as user's turning (orientation change) or jumping/crouching (these do not result in lateral or X-Y plan “position change”), will use 1:1 motion tracking of the HMD (external to the footwear system) and will not result in moving/speed increase or decrease)

In one related embodiment, user kneeing is detected by either pressure pattern sensors below user's feet or by using pose/orientation sensors on foot or on user's legs.

As the suitable systems, means, methods here (such as but not limited to sensors, detection methods, processors etc) may be embodied in a wide variety of forms, some of which may be quite different from those of the disclosed embodiment. Consequently, the specific structural and functional details disclosed herein are merely representative;

### BRIEF DESCRIPTION OF THE DRAWINGS

The foregoing features of the invention will be more readily understood by reference to the following detailed description, taken with reference to the accompanying drawings, in which:

FIG. 1 depicted a “motion profile” for a user intentional movement, in this case a forward translation movement. In this case user's body initially accelerate to start moving and later decelerate to stop moving as shown in (a), the pressure pattern changes can be detected on the frontal feet as shown in (b) pressure of the frontal foot's ball (frontal) area and (c) pressure of the frontal foot's heal (back) area means a heel to toe transfer of body weight, as well as from the overall (average) pressure on the back foot (moving away) as shown in (d).

FIG. 2 shows scenarios of a modular detection/processing unit 201 can be detached and re-attached to different places to perform measurements of motion as and aspects of different part of body, via a connector 202 when connect to a belt 203 or 204 can be used as body/torso motion detector in which case the IMU in the unit itself can provide pose (such as 3D acceleration, rotation and magnetic orientation) measurements and additional measurements is provided through the “bus” which link to additional sensors (such as for foot pressure pattern) that connects to the unit 201 via the connector 202.

What is claimed is:

1. An apparatus to provide intuitive and motion-sickness-reducing navigation in VE by detecting user initiated intentional motion within a limited range which similar to the range of a single step, comprised of:
A “head/body motion detection” system that is capable of one or the combination of the following:
1) detecting user body torso motion by using wearable fixed on user's torso which operationally connects to a computer based processing system for determine user intensions from body movements and/or status change and communicate body motion or pose/status changes detected in real-time to said system; or
2) detecting head motion or operationally connecting to detection mechanism (such as those of a HMD) and capable of getting the motion measurements in real time; in this case the rotation of user's head/HMD is not considered to be also the body rotation unless otherwise deliberately choose by user;
and mechanism to determine the rotation of user's body such as but not limited to sensor system that could be integrated with systems mentioned in a) or b) for detecting user torso motion;
a system for detecting user's feet motion by using wearable fixed on user's feet which operationally connects to a computer based processing system for determine user intentions from body movements and/or status change and communicate foot motion/pressure pattern change detected in real-time to said system;
means for communicating/operationally connecting to a computer implemented VR/AR/Game/Simulation system which present a virtual world to user so that the input from body/torso motion detection system and the foot motion/pressure change detection system can be used towards modifying or make changes to the virtual world system on user's self-motion.

2. In a apparatus according to claim 1, using input from body/torso motion detection system and the foot motion/pressure change detection system towards modifying or make changes to the virtual world system on user's self-motion including:
deciding if user's activity is intentional by comparing the direction, timing and duration of the motion from body and feet and if considered together the two time sequence match a profile of a intentional movement such as translation, said system will start modifying or make changes to the virtual world system on user's self-motion, such as velocity relative to the virtual world, according to such intentional changes in real time, such modification does not render user to have motion sickness with ways to make the differences between the artificial motion state and that in real life difficult to notice or unnoticeable, for example by using noise to mask related differences or make the level below normal person's sensing threshold for acceleration or rotation, or other methods that introduce little motion sickness, for example the difference is added mainly at phases when user's acc or velocity is diminishing.

3. In an apparatus according to claim 1, using input from body/torso motion detection system and the foot motion/pressure change detection system towards modifying or make changes to the virtual world system on user's self-motion including:
divided the motion of user into sessions which can be determined by events such as (but not limit to) user's stepping activity, for example only when user taking a new step and then the foot was landed and user put more than trivial, for example 15% of normal weight on it, a new “step session” can begin; otherwise if no new step was taken then any “modification” of user's motion will be under the current “step session”, and no motion mode change such as change from turning to translation or vice versa is allowed during the same session, only on the same direction with aptitude modifications; Changing from rotation to translation or vice versa is only possible after a new step is detected/confirmed;
If user's foot landed with more than 15% whole body weight on frontal foot and the body direction is already departed from that of the previous step session, and increasing, such session can be determined as a “turning” session; to determine if a landed feet is forward or backward, there could be multiple ways, one way using just the pressure sensor is to referring to the “landing pressure pattern sequence” to determine—if the pressure pattern is from heal to toe, it can be assumed the foot is landing forward, and if the pressure pattern is toe to heal, it can be assumed the foot is landing backwards, same can be applied to left to right side ways situations.

4. In an apparatus according to claim 1, any new movement direction or turning will require user to begin a new step and the current speed could be dropped significantly (according to some configurable parameter such as dropping rate or ratio) in the process of taking another step, so that the new direction does not create a lot of centrifugal forces in virtual world for user to compensate.

5. In an apparatus according to claim 1, further including using the detected body/torso acceleration or head acceleration (or obtain measurements from related detection system such as that of the HMD) mainly in the direction of gravity (and might together with rotation) to determine if user is performing jumping or the landing/cushioning activity, by checking the acceleration of body/head against “jumping or cushioning activity criteria”; In case user landing but do not performing cushioning activity, the VR system might generate visual effects such as shake, blur or black out according to the simulated impact in the virtual world.

6. An apparatus for user to perform anti-motion-sickness navigation/self-motion in immersive environment VR/AR/3D and (optionally) less-restrictive Aiming/engagement/target selection comprised of:
a) means for Detecting user's body/torso motion or head motion (or means to obtain such data from VR/Simulation system/HMD), for example by using IMU worn by user and move together (tightly) with user's body;
b) means for Detecting user's feet motion or pressure change (that operationally connect to the body motion sensing unit) to provide additional verification signal/cross check for filtering out unintentional noise for motion status change (in virtual world) for example by using filters, adaptive filters or control algorithms such as but not limit to PID control algorithms, Kalman filtering and etc, in case said motion is deemed to be “noise” or “conflict” with current motion, it might be filtered, dampened or discarded according to configuration or filter settings.
c) A computer based control system based on the inputs of body motion and related feet motion/pressure change verification signals, to output navigation/self motion control signal to VR system this control system is connected to, for modifying (could be at time only when action confirmed to be intentional), causing speed/velocity change of user in virtual world according to the dir of the action (parallel to) and aptitude of the detected motion status change in real life, in real time, could be for example at times user's action passed max speed and before user's change's speed/distance stops;
So that the user can experience a much more realistic and convenient motion and aiming with much less possibilities of motion sickness.

7. In an apparatus according to claim 6, while there is translation or rotation self-motion speed, The self-motion direction can only be changed when a NEW step in real word is taken.

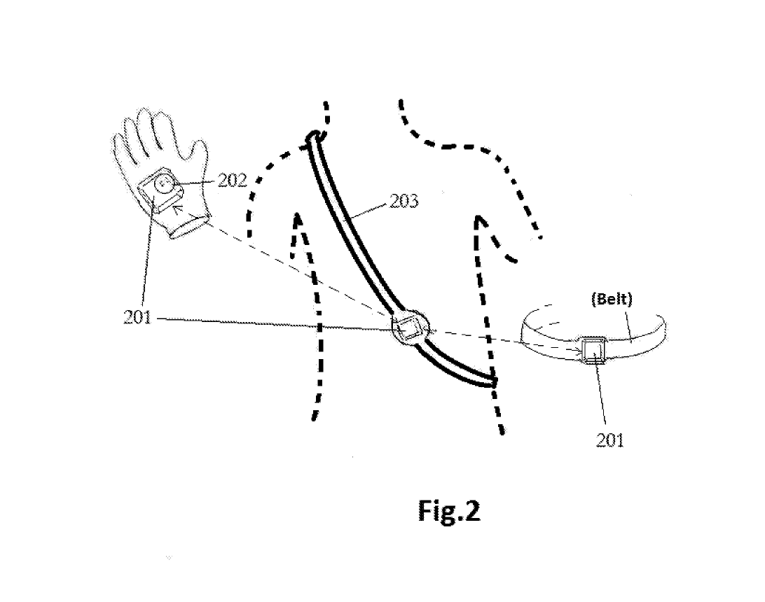

8. In an apparatus according to claim 6, the nodes of sensing/processing unit is modular which can be detached and re-attached to other places of the body wearables such as but not limited to belts, gloves that have connectors for attachment in order to provide measurements in different scenarios (for example like in FIG. 2).

9. In an apparatus according to claim 6, A VR/AR/Game/Simulation system that connect to said apparatus and allow free aiming plus free movement (3 separated and independent direction of view, aiming and moving/walking) by using the body/torso rotation/orientation measurement provided by the body motion detection unit of the apparatus and use it for body/self-motion moving direction which is independent from HMD looking direction or weapon aiming direction.

10. An apparatus to enable comfortable locomotion/navigation of a user in a virtual environment which reduces the level of or minimizes VIMS for some longer than trivial usage—such as more than 3 minutes—comprised of:
Means for detecting user motion in a limited range such as within one step including body/head/CG and possibly also with feet/leg movement, such movement including translation and turning; Said means can either perform or operationally connected to one or more computer implemented systems that perform the steps of convert motions suitable for reducing/minimizing VIMS purpose which is parallel to the direction of moving such as those directions user can move in VE, and optionally after determine if such movement is intentional, into VE-appropriate-mapping signals for locomotion navigation/modification of self-motion in VR in real time that can rendering the self-motion speed in VE visually by this motion.
So that what user sees in VR and the cues user got from his/her inner ear (vestibular) have reduced/minimized conflict at a level either is unnoticeable, such as below the noticeable threshold, for over 80% of the population or enable most (over 80%) of the population to feel comfortable in navigation continuously for prolonged period of time, such as more than 15 minutes, in a immersed virtual environment.

11. In an apparatus according to claim 10, said means for detecting user motion in a limited range (such as within one step) including:
1) a mechanism for (reliably) detecting CG change caused/rendered (or resulted) foot/feet supporting changes including movement or pressure distribution change in real-time low latency (such as lag less than 20 ms),
2) together with mechanism detecting body orientation changes in real-time low latency suitable for VR/AR (such as less than 20 ms) including at least turning around axis vertical to the ground.

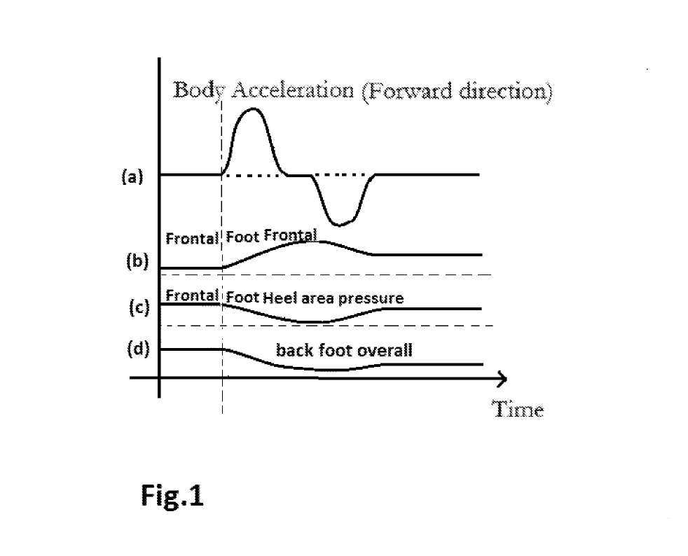

12. In an apparatus according to claim 10, further include means (Steps for determine if the motion/change is intended/suitable for locomotion (self-motion) in VE), comprised of:
A computer implemented system use the input from body/torso motion detection system and the foot motion/pressure change detection system and deciding if user's activity is intentional by comparing the direction, timing and duration of the motion from body and feet and if considered together the 2 match a profile of a intentional movement such as translation (maybe similar to that of FIG. 1), said system will start modifying or make changes;
A method to generating cues (that is suitable for VIMS reduction) for navigating/modifying user's motion status in visual environment that reduce/minimize VIMS of user including:
Generating cues (motion direction/turning direction) for virtual worlds (in real-time low latency suitable for VR) consistent with user's head/body motion in real world utilizing physical acceleration/motion provided by user's motion within one step so it is roughly consistent (or under noticeable threshold or under comfortable threshold for prolonged such as longer than 15 minutes use in VE) with what normal user feels with his/her vestibular and other senses for acceleration.
So that VIMS is canceled/reduced/minimized in a intuitive way in which physical acceleration/motion provided by user's motion match (or reduce the inconsistency) the artificial acceleration/motion perceived by user from visual from the virtual environment that might be otherwise inconsistent or conflict with user's vestibular senses.

13. A method/apparatus to allow intuitive, similar to real life, and “linear/continuous” way for navigation/exploration (with self-motion) of a virtual world in which user can navigate similar to a way user navigate in real life, presented by a immersive VE for a user towards minimizing VIMS and without the need of using hand(s) (just like in real life) for navigation includes/comprised of:
1) A means for detecting/identifying user (intended) body/CG movement that is consistent with navigation direction in VE such as translation horizontally (parallel to the ground) or turning around an axis substantially vertical to ground. (for example tracking means for foot and body motion/position that can track both foot and body movements in real time with “vr qualifying low latency” in which the latency of detection is lower than the requirement for preventing motion sickness usually significantly under 20 ms to allow the whole “motion to photon” cycle of VR to be completed under 20 ms)—So it needs to detect (either directly or indirectly) in low latency when user performing body CG moves or the supporting (such as foot pressure pattern) of user GG changes (deemed to be motions intentional) for the purpose of navigation such as translational movement (horizontally movement in the VE), rotation (around axis vertical to the ground), jumping or crouching, which could means filtering out motions detected other than these purposed (such as with excessive tilt, so short unintentional sway) (using some threshold on speed which can be inferred by accelerometer data, distance (support percentage), duration);
2) For translation this means a threshold for example at least ¼ of normal people's walking speed (0.6 m/sec, ¼ is 0.15 m/sec) with relatively long period of time or travel distance (such as half step) is desirable to filtering out the noises. For turning this requires a new step and at least 3 degree of turning and continue angular speed to begin turn on.
3) Communicate/inform VE with “detected intention” for rendering modification in real time and low latency suitable for vr/ar purpose, or before user's motion finished (all speed diminished for this intentional movement direction)> of user movement state in the VE, such as transnational speed or turning/facing direction, Causing an “artificial speed/acceleration” to be added to the avatar other than what user already seen in VE (such as but not limited to HMD, CAVE) (such speed will continue until user shift weight back, even when user stopped moving in real life) in a way not very noticeable to user. So that VIMS can be avoided/minimized by user's motion which is intuitive and provide (consistent) cue(s) of motion to vestibular senses for the motion user sees in the VE system.

14. In a method/apparatus according to 13, the speed of motion relative to the virtual world have a upper limit or conditional upper limit, for example similar and not significantly higher than human being's max motion speed in a similar situation in real life—for example but not limit to: faster than twice the speed of human running speed. Further, the limitation could be conditional—for example if user are moving in a wide open space/area (in virtual world) with low “visual angular speed” the speed limit is higher, while in a closed space (in virtual world) with high “visual angular speed” the speed limit is lower, maybe even slightly lower than max human running speed to be comfortable for most users.

15. In a method/apparatus according to 13, the criteria (threshold) and resulting “detected intention” is like the following: once user top speed surpass certain limit, or translation distance greater than how many, we can set a minimal speed when user slowing down (like some thing can be surged); Said means for detecting and identifying user (intended) body/CG movement that is consistent with navigation direction in VE such as translation parallel to the ground

16. In a method/apparatus according to 13, further includes: Means (Steps for determine if the motion/change is intended/suitable for locomotion (self-motion) in VE comprised of:
A computer implemented system use the input from body/torso motion detection system and the foot motion/pressure change detection system and deciding if user's activity is intentional by comparing the direction, timing and duration of the motion from body and feet and if considered together the 2 match a profile of a intentional movement such as translation (maybe similar to that of FIG. 1), said system will start modifying or make changes.

17. In a method/apparatus according to 13, for detecting user body motion direction within one step range and use such motion direction and top speed (of the CG movement) to (factor can adjust) determine the moving speed (continues) of the user in the virtual space proportionally including:
1) determine/estimate Center of Gravity movement combined with body orientation, by for example by detecting user's feet movement in order, for example if user keep their weight (like more than 50%) on the feet in the front of the direction he/she intended to move this could represent user's intention to move along with this direction in the virtual world and it feels natural to user. By detecting such CG movement for an estimation of “vestibular/inner ear sensed” motion status which is closely related to the motion status sensed by vestibular/inner ear and use such estimation (such as acceleration, speed) to drive the movement of visual, with washout filters (maybe similar to the algorithm of the washout filter of a flight/vehicle simulator in similar/comparable situations) So that VIMS can be avoided/minimized by user's motion which is intuitive and provide (consistent) cue(s) of motion to vestibular senses for the motion user sees in the VE system.

18. An apparatus for reliably and low-latency detecting and identifying user intended body/CG movement consistent with direction(s) user can navigate to in VE (such as translational parallel to the ground) and thus can be used (suitable) for navigation commands including/comprised of:
1) a mechanism for (reliably and low latency) detecting CG change caused/rendered (or resulted) foot/feet supporting changes including movement or pressure distribution change in real-time low latency (such as less than 20 ms of lag “from motion to photon”),
2) mechanism detecting user body's left or right turning (or: turning around axis substantially vertical to the ground) in real-time low latency (such as lag less than 20 ms)
3) that upon “low latency” realtime detection of user's (intended) CG movement the camera/avatar in VE representing user view point can be changed according to speed vector of the user's motion
So that VIMS can be avoided/minimized by user's motion which is intuitive and provide (consistent) cue(s) of motion to vestibular senses for the motion user sees in the VE system

19. In an apparatus according to 18, further include:
Means (Steps for determine if the motion/change is intended/suitable for locomotion (self-motion) in VE comprised of: A computer implemented system use the input from body/torso motion detection system and the foot motion/pressure change detection system and deciding if user's activity is intentional by comparing the direction, timing and duration of the motion from body and feet and if considered together the 2 match a profile of a intentional movement such as translation (maybe similar to that of FIG. 1), said system will start modifying (or make changes)
So that by “low latency” detection user's intended CG movement and use it for VIMS reducing/minimizing motion-indication/navigation by
1) modifying the VE or avatar in VE of the speed vector “consistent” or similar to the speed vector of the user's motion, the amplitude/magnitude of translation can be (for example proportion to the top speed) determined by a mechanism for (reliably and low latency) detecting CG change caused/rendered (or resulted) foot/feet supporting changes including movement or pressure distribution change in real-time low latency (such as lag less than 20 ms)
2) from a mechanism detecting user body's left or right turning (or: turning around axis substantially vertical to the ground) in real-time low latency (such as lag less than 20 ms) the body orientation can be determined which can be used to determine user's movement/turning intension.

20. In an apparatus according to claim 10, detecting body CG movement including using optical means such as markers/beacons using outside cameras, or receivers such as light house trackers, maybe together (2) which could also use with Optical/Ultrasound/pressure sensor on the attached to footware/Or using matt-like outside foot pressure sensor (such as IMU wearable, or outside optical sensors, beacons, patterns) as well as means to detecting user's body turning such as around axis vertical to the ground, such as by optical/ultrasound (such as sensors, beacons, optical patterns, reflectors etc.) or IMU means worn close to user's CG.
